(19) United States
(12) Patent Application Publication
(10) Pub. No.: US 2024/0169343 A1
(43) Pub. Date: May 23, 2024

(54) SYSTEM AND METHOD FOR A PAYMENTS SYSTEM

(71) Applicant: REWIRE HOLDING LTD., London (GB)

(72) Inventors: Jose Luis Merino GONZALEZ, London (GB); Jesus Ruiz GONZALEZ, London (GB)

(21) Appl. No.: 18/283,954

(22) PCT Filed: Mar. 25, 2022
(86) PCT No.: PCT/GB2022/050753

§ 371 Date: Sep. 25, 2023

(30) Foreign Application Priority Data
Mar. 26, 2021 (GB) 2104328.6

(51) Int. Cl. G06Q 20/32; G06Q 20/20

(52) U.S. Cl. CPC G06Q 20/3278; G06Q 20/20; G06Q 20/3224; G06Q 20/326

(57) ABSTRACT

A system and method of operating a payments system using a Custom Made Device (CMD) not requiring any power supply, or such CMD in combination with an adapted smartphone (AS) jointly, can form a novel point of sale (POS). This invention improves on the prior art shortcomings allowing merchants and users alike more choice of using this invention for different payment systems that makes use of a novel Custom Made Device (CMD) or a novel Point Of Sale (as a combination of using a CMD and an adapted smartphone) increasing competition in the marketplace in a more reliable way than without using the CMD. Additionally the invention increases the reliability of users transacting directly between them through their smartphones or such other devices by instead of interacting directly between the user device to interact through the Custom Made Device of this invention acting as a passive repeater between both devices.

### FIELD OF THE INVENTION

A system and method of operating a payments system to automate certain payment processing aspects through the use of wireless devices adapted as per this invention. Aspects of the disclosures relate in particular to a system and method of enabling a Custom-Made-Device “CMD” to be part of the payments system in order to allow wireless devices, adapted as per this invention, to act as a Mobile-Paying-Device “MPD” where the user of such MPD can make payments through the CMD to a Mobile-Receiving-Device “MRD” where the user of such MRD can be another user or a merchant who receives payment(s) through the CMD for example as a point of sale payment or as cash deposit by a user to a merchant, or in a different embodiment the MPD can be used by another user or a merchant who makes payment(s) through the CMD; for example as a refund, cash back or as cash withdrawal from merchant to a user.

Other aspects of disclosures include or consist of enabling those adapted wireless devices as per this invention to perform payments or receive payments through the Custom-Made-Device. Secure transaction communications between adapted wireless devices and the system server are facilitated through the wireless devices communicating with each other through a custom-made-device whereby the distance between the Mobile-Paying-Device and the Mobile-Receiving-Device is more than the acceptable distance for an acceptably ultra-low power transmission bit error rate to ensure reliable communication between those devices, thus each of the Mobile-Paying-Device and the Mobile-Receiving-Device communicate with each other through the Custom-Made-Device.

This way a single transaction between two parties requires the server to receive a separate request from the Mobile-Paying-Device(s) and the Mobile-Receiving-Device(s) containing a same unique transaction identifier be they with a same or different time-stamp. Each of those transaction requests is created as follows:
a single Mobile-Receiving-Device first request through the Custom-Made-Device by going near it, to receive payment from a single Mobile-Paying-Device at the moment the Mobile-Paying-Device goes near the Custom-Made-Device.
a single Mobile-Paying-Device first request through the Custom-Made-Device by going near it, to make a payment to a single Mobile-Receiving-Device at the moment the Mobile-Paying-Device goes near the Custom-Made-Device.
a single Mobile-Receiving-Device first request through the Custom-Made-Device by going near it, to receive a proportional part payment from a preestablished number of Mobile-Paying-Devices at the moment each of the Mobile-Paying-Device goes near the Custom-Made-Device at different times one after the other.
a preestablished number of Mobile-Paying-Device, first one then the other until the last preestablished number at the moment each of the Mobile-Paying-Devices go near the Custom-Made-Device at different times one after the other, request each to make the proportional part payment to a single Mobile-Receiving-Device which is at all time near the Custom-Made-Device.

All the previous mentioned devices when nearing the Custom-Made-Device and communicating with the other device near the Custom-Made-Device yet those devices are not near enough to each other to communicate reliably, yet those devices are communicating reliably through the Custom-Made-Device. All those devices (be they Mobile-Paying-Devices or Mobile-Receiving-Devices) sent an encrypted transaction request to the system server, where the system executes all such associated transactions with a same unique transaction code.

Such unique transaction code per transaction that are not executed within a given time by the server due to any missing counter party, are deleted from the server when that time expires (in example after 24 h).

All wireless devices, be they Mobile-Paying-Devices or Mobile-Receiving-Devices, each of them can be in embodiment from users transacting between them or in another embodiment between (businesses merchants transacting between them or in another embodiment between a single or multiple user(s) transacting with a single merchant or yet in another embodiment between a single or multiple merchant transacting with a single or multiple user(s).

All the wireless device users and merchants in one embodiment are authenticated and identified as KYC (know your customer) in the case of end-users, or as KYB (know your business) in the case of merchants or businesses.

In this way the transaction execution is always between identified or authenticated system server users' accounts (meaning never anonymous) yet the transaction petitions between all the adapted wireless devices of an associated transaction and the system server adapted as per this invention, are performed anonymously, thus protecting user's data privacy.

### BACKGROUND OF THE INVENTION

Traditional payment systems are evolving from physical payment methods to so called contactless ones and so are the online and in-store payment methods evolving in search of increased user data privacy or a more secure payment system to reduce fraud.

The internet and regulation helped create the right framework for new players to operate as a payment processing business providing online or in-store payment facilities to end-users and merchants.

The payments services provided between traditional and new entrants have become less on the products offered and more in the way they interface with end-users and the ease of creating a merchant account online.

Despite the amazing improvements in digital payment services and a wide variety of competing companies to choose from by end-users, there are still certain shortcomings that need to be improved or overcome.

Some of the shortcomings of the prior art are;
(i)—in the case of a traditional payment processing firms that relied traditionally on physical cards for payments or cash withdrawals, there is the issue of cash deposits that most ATMs do not allow for all such variety of physical cards.
(ii)—in the case of intermediaries between end-users and card providers, such as big brands with massive reach out to users, such as for example smartphone manufacturers that control the operating systems rely on a middle man approach, virtualizing the traditional physical card as virtual card in their operating system to remove the requirement of needing a physical card and simply pay with a smartphone through so called contactless payment method yet adding an additional cost to the merchant and potentially in certain cases passed on to the end-user if the merchant passes that cost in the price itself. Whereas the prior art contributes to ease of use, it does not contribute to reducing the cost to end-users nor merchants.
(iii)—in the case of unbanked end-users, the prior art does not provide a payment method to facilitate financial inclusion as traditional payment systems rely all on end-users first having opened a bank account and/or having a loadable payment card of one of the traditional payment systems before being able to pay through the traditional or new entrants payments system.

As an illustration of this, according to the UK's “FCA (financial conduct authority), The financial lives of consumers across the UK Key findings from the FCA's Financial Lives Survey 2017, 20 Jun. 2018” and published the following, quote “The FCA has published research estimating that 1.3 million UK adults are ‘unbanked’, meaning they do not have a bank account.” Un-quote. See https://publications.parliament.uldpa/cm201719/cmselect/cmtreasy/1642/164205.htm#footnote-194.

That 1.3 million on a population of just over 60 million is a staggering ratio for a so-called developed country. On the other side of the spectrum, in a developing country like Mexico, according to a major United States investment bank, there are in 2019 around 42 million people with no bank account in Mexico.

According to “The world bank” report of “Washington, Apr. 19, 2018” quote “Globally, 69 percent of adults—3.8 billion people—now have an account at a bank or mobile money provider, a crucial step in escaping poverty. This is up from 62 percent in 2014 and just 51 percent in 2011.” Un-quote. In other words, 32% of global population did not have bank account in 2018, which is a staggering 1.2 billion people. See https://www.worldbank.org/en/news/press-rel ease/2018/04/19/financial-inclusion-on-the-rise-but-gaps-remain-global-findex-database-shows.

This phenomena of underserved or unbanked people requires a technical solution as well as a socially responsible solution to aid financial inclusion.
(iv)—Another shortcoming is the potential fraud increase due to the fact that more and more so called contactless are being performed, partly or mostly helped by the pandemic that started in 2020 and still affects the daily lives of a global population all through 2021. Covid-19 resulted in increased contactless payments to avoid physical contact and came worth an industry wide increase in the maximum contactless payment limits, in example in Europe from EUR 25 in 2019 to EUR 50 in 2021 or from GBP 30 to GBP 45 in the UK. The fact that a contactless virtual or physical card payment is performed without any identity check at point of sale, with a 50% in the UK and 100% in Europe, increase in the maximum amount, typically exposes the fraud potential to increase with a similar amount. This prompted the regulators to force new regulation to require card payment providers to implement a two-factor verification on certain payments online or physical. For example, every certain number of contactless payments to force a PIN transaction requiring the user to enter his PIN and expose the potential risk of contagious of current or future similar or different virus as was evidenced during the current almost 2 years lasting Covid-19 pandemic.
(v)—Yet another shortcoming of the prior art is that all prior art of payment systems, in the event of a virtual card payment system using a smartphone as the paying party, requires both the merchant and the smartphone user to have internet at the moment of payment. In the event of a physical card payment system, it requires the merchant point of sale device to have internet access at the moment of payment. Some merchants resolved this last issue by not allowing prepaid card users to pay with their physical nor virtual card, when the merchant has no internet access at the moment of payment, such as is the case in certain airlines that do not have inflight real time internet access, or certain road toll payment booths that are in a none mobile or fixed line internet coverage area to ensure that the payment transaction can verify that the prepaid card actually has sufficient funds to pay for the transaction to confirm or decline it.
(vi) Finally, in a different shortcoming is the so-called contactless payment means from a smartphone or a physical card to the merchant's payment collection device. In majority of the cases the payment is performed through a communication between the user payment device (physical card or virtual card in a smartphone) through NFC (near field communications) with the merchant device (point of sale device or an adapted smartphone) or in other cases replacing the NFC between the user device and the merchant device by an ultrasonic audio communications method where the microphone is the receiver and the loudspeaker is the transmitter. It is clear that the longer the range of the so-called contactless transceiver is (NFC, audio, or any such other) the more susceptible it becomes to fraud by potential hackers intercepting and acting as a “man in the middle” as a means to defraud users, merchants and card issuers and insurance companies. Also the fact that many users are using covers for their smartphones to protect them from falls or as a trendy or fashion statement, it makes the NFC between certain device combinations (for example, but not limited to, in the event the paying user device and the payment collecting merchant device both are a smartphone) less reliable due to the distance between both devices NFC antennas being too far apart in some case thus not being reliable across the board resulting in certain payments failing for completing successfully thus affecting negatively sales revenues.

Although traditional payment methods are perfectly workable as a business as they were profitable, the fact is that they do not provoke any major difference between traditional and new payment systems, meaning that users are unlikely to benefit from lower pricing, less fraud, more reliability, less internet access dependant and consequently are less likely to contribute significantly to lower the financial inclusion levels. It seems, at first sight, that the recent times increase of penetration of mobile phones has had a far bigger impact on reducing the financial inclusion levels than technical innovations in recent times in the payments systems industry sector.

Our invention resolves all the prior art shortcomings because our innovative payment system allows for the following;
(a)—our payment system is designed to allow for merchants to accept cash deposits and withdrawals within the limits of the law in each region in order to help with our technical solution for those underserved or unbanked users who do not have in their vicinity a cash deposit ATM or do not have a bank account with a physical branch nearby. This is key as rural areas are seeing less and less traditional banks in their villages with less than a certain population size. Merchants using this invention would be able to take over the financial services traditionally offered in the past by banks or other financial institutions, especially in those regions where users are still using mostly cash instead of electronic money.
(b)—reducing the middle man between the merchant and the end-user to collect a payment by using this invention and thus allowing to reduce the cost to the merchant and as a consequence the end-user, if the merchant passes on part of the cost saving to the end-user.
(c)—our innovative system will allow for unbanked or users who do not have a traditional payment card for whatever reason, to make payments just with their smartphones at merchants using this invention, without requiring any virtual card of a traditional service supplier nor requiring any virtual account linked to any traditional virtual/physical card of a traditional service supplier through any smartphone manufacturer or any other 3rd party that is not using this invention.
(d)—this invention in combination with prior art from the same inventor as this invention will allow this innovative payment system, of this invention, to:
   allow a user with an adapted smartphone with this invention to pay a merchant with an adapted smartphone with this invention, wherein one of the two smartphones has no internet at the moment of the payment transaction, and
   allow a user with an adapted smartphone with this invention, where this user smartphone includes a traditional virtual card from a traditional card provider (be it prepaid, debit or credit) to pay a merchant with an adapted smartphone with this invention, wherein one of the two smartphones has no internet at the moment of the payment transaction.

### BRIEF SUMMARY OF THE INVENTION

The present invention is designed to solve real issues in people's lives, such as (i) improving access to cash deposit and/or withdrawals facilities with the aim to allow merchants to have an additional revenue stream but also unserved or underserved regions inhabitants, like rural areas, to have access to cash deposits and/or withdrawals, (ii) reduce middle man in the payments transactions process between the merchant and the end-user with the aim to reduce cost to the merchant, (iii) reduce the hurdles for end-users to take part in electronic money payments with the aim to ease the access to electronic payments to unbanked or underserved communities, (iv) improve access to electronic payments by end-users who do not always have access to the internet, (v) improve access to electronic payments by end-users of cards where the merchant does not always have access to the internet, (vi) reduce the so called contactless payments to users not having to touch the merchants device to be truly contactless when performing electronic payments, for example aiming for not having to fill in the PIN on the merchants device to authenticate or not having to touch the merchants device with the users device.

The present invention is designed to overcome the shortcomings of the prior art and to provide an automated way of resolving the shortcomings of the prior art specifically for Internet enabled wireless devices capable of downloading a software module, also referred herein as an App or Application, from the Internet. Such software module when downloaded onto the Internet enabled wireless device renders the software module operable to communicate with other wireless devices with the same such software module downloaded on to such other wireless device nearby.

The wireless devices herein are those smartphones, tablets and any such other different devices that can download a custom module of this invention or where such custom module can be embedded by a 3^{rd} party or by the end-user itself and are then capable of communicating with other devices of this invention.

### BRIEF DESCRIPTION OF THE SEVERAL VIEWS OF THE DRAWINGS

FIG. 1 represents a diagram of a typical embodiment of the present invention, forming an electronic payments system.

FIG. 2 represents a payment transfer system embodiment of the present invention, Wherein, SP0 is a user adapted smartphone and SP2 is a merchant's adapted smartphone.

FIG. 3 represents a payment transfer system embodiment of the present invention, Wherein, SP0 is a user payment Card and SP2 is a merchant's adapted smartphone.

FIG. 4 represents a payment transfer system embodiment of the present invention, Wherein, both SP0 and SP2 are user's adapted smartphones.

FIG. 5 represents a cash deposit/withdrawal embodiment of the present invention, wherein SP2 represents a merchant adapted smartphone, SP0 is a user adapted smartphone.

FIG. 6 represents a cash deposit/withdrawal embodiment of the present invention, wherein SP2 represents a merchant adapted smartphone, SP0 is a payment Card.

FIG. 7 represents the Custom Made Device in different embodiments of the present invention. 7a shows an actual prototype whilst 7b shows a more advanced prototype of different sizes. 7c shows a finished goods Custom Made device manufactured as a final prototype ready for production start upon presentation of this invention to the corresponding patent office(s) for intellectual property rights protection.

FIG. 8 represents the Custom Made Device (7c of FIG. 7) showing all the different parts of FIG. 7c as an embodiment of the present invention.

FIGS. 9a and 9b represent the Custom Made Device (7c of FIG. 7) showing all the different dimensions of the mechanical plastic custom parts of FIG. 8 as an embodiment of the present invention.

### DETAILED DESCRIPTION OF THE INVENTION

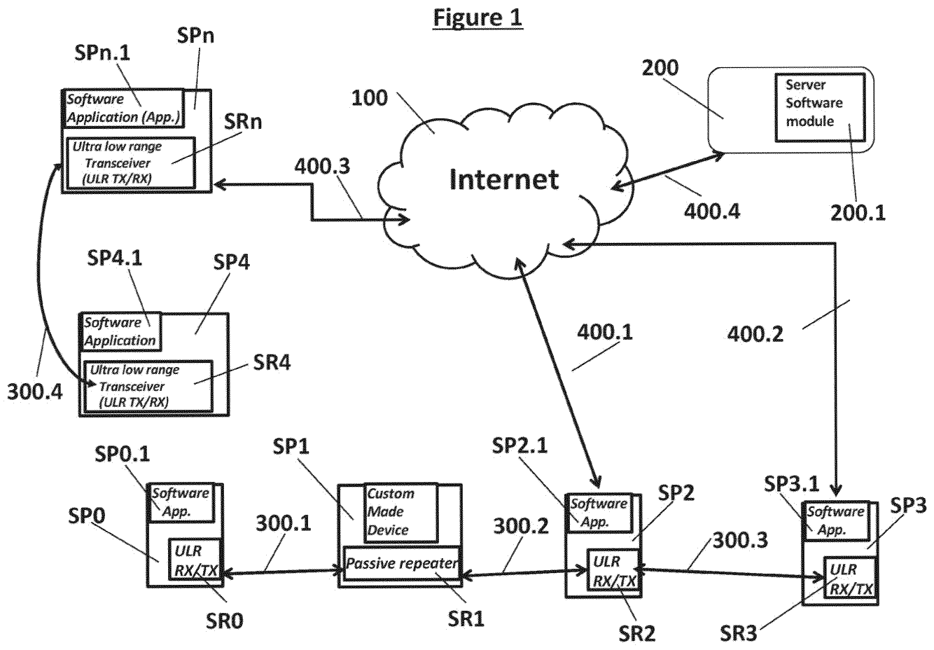

Specifically, FIG. 1 is a typical embodiment of the present invention, applicable amongst others but not limited to an electronic payments system.

The system of FIG. 1 comprising of at least one or more Servers, so called “in the cloud” (200) with a proprietary software module (200.1) to enable communications through (400.4) to the internet (100) to communicate with the devices, also known as smartphones or tablets or any such other communications devices, (SP0, SP2, SP3, SP4, . . . , SPn) with a proprietary software application (SP0.1, SP2.1, SP3.1, SP4.1, . . . , SPn.1) downloaded into each respective device, communicating directly between them or communicating between them through a “Custom Made Device” (SP1).

Each device, except for the “Custom Made Device” (SP1) is enabled to access the internet, shown in FIG. 1 as (400.1, 400.2, 400.3).

All devices and the system server (200) and the server software module (200.1) communicate with the devices through the internet (100) through the communications channels (400.1, 400.2, 400.3). Certain devices are additionally enabled to communicate with each other through ultra-short range communications channels (300.1, 300.2, 300.3, 300.4, . . . ), such as for distances up to a few centimetre through NFC (near field communications), BLE (Bluetooth low energy) or Ultrasound audio or light emitted communications or any such other ultra-low range two way communications means (SR0, SR1, SR2, SR3, SR4, SRn), by the Software application or also known as “app” (SP0.1, SP2.1, SP3.1, SP4.1, . . . , SPn.1). In the event of 2 devices SP0 and SP2, the communication means between them is through a passive repeater Custom Made Device (SP1) which receives the transmission from SP0 and relays it to SP2 and receives the transmission from SP2 and also relays it to SP0 passively.

This passive repeater can be in one embodiment an NFC-, BLE-, or any such other passive-antenna near SP0 and a separate same passive antenna near SP2 whereby both antennas are electrically connected with each other, passing on the received signal from one antenna to the other bi-directionally in a passive way without any active components.

In another embodiment the passive repeater SR1 can be a mechanical guide of light, built into the Custom Made Device SP1 between the area near the side of SP0 and the side of SP1 guiding the light emitted by SP0 unidirectionally to SP1 and a separate mechanical guide to pass on the light emitted by SP1 unidirectionally to SP0, thus having bi-directional light guided as two separate unidirectional mechanical guides.

In yet another different embodiment the passive repeater SR1 can be a mechanical guide of sound, built into the Custom-Made-Device SP1 between the area near the side of SP0 and the side of SP1 guiding the sound emitted by SP0 unidirectionally to the sound receiver of SP1 and a separate mechanical guide to pass on the sound emitted by SP1 unidirectionally to sound receiver of SP0, thus having bi-directional audio guided as two separate unidirectional mechanical guides. The audio can be in the audible or non-audible frequency range, in example ultrasound band, or can be frequency tones used as digital transmission where each tone or consecutive tones form a digital bit similar to DTMF but in different frequency ranges or it can be a modulated frequency signal by one device that is demodulated by the other device and vice versa.

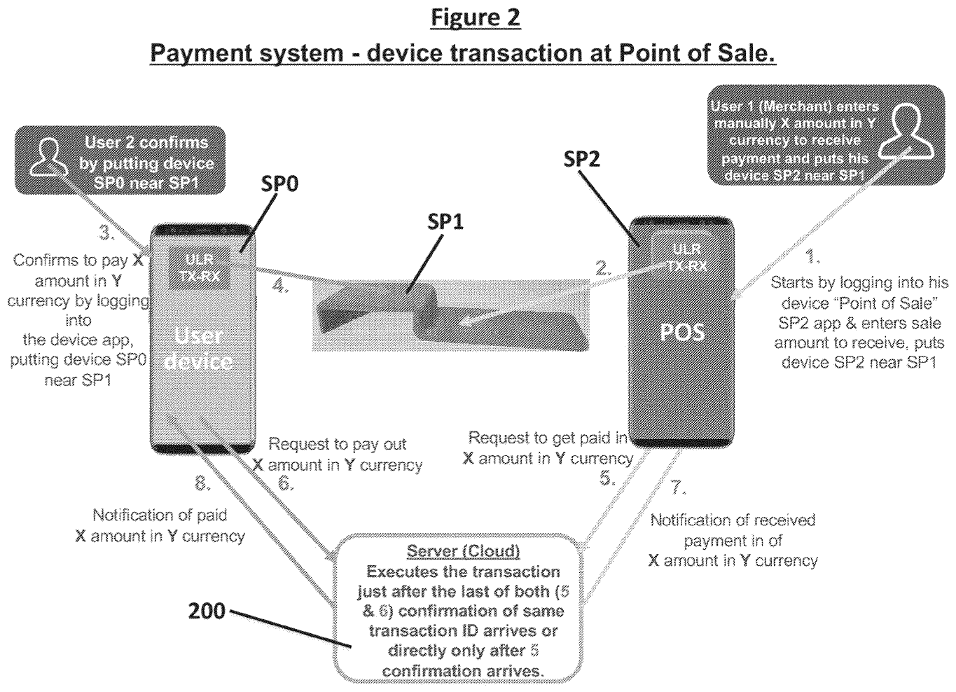

FIG. 2 represents an embodiment of the present invention, of a payment transaction at a point of sale, whereby the user of SP2 is a merchant whereby downloading an application software (SP2.1 of FIG. 1) configures the device SP2 into a point of sale (POS) device SP1. The merchant (user of SP2) enters the amount that the buyer (user of SP0) needs to pay for the merchandise or services rendered by the merchant. The merchant then puts his POS device SP2 on the Custom Made Device (SP1) lower longer end flat side of device SP1 which acts as a passive repeater between the merchant device and the purchaser device on the opposite side of SP1. The user who makes the purchase confirms the purchase by approaching his device SP0 near the Custom Device SP1, on the higher area flat side, which functions as a passive repeater between device SP0 and device SP1.

In one use case one of the two devices, SP0 or SP2 has no internet connection and in which case the other device shares its internet with the device that has no internet by sharing the password of the internet sharing medium through device SP1.

The merchant device can be configured to require both devices SP0 and SP2 to send a separate transactions confirmation to the server 200 or just one of both devices, giving the priority to the merchant device if that device has internet connection at the time of the transaction.

The server 200 may be optionally configured to send a confirmation notification only to the merchant device or to both devices, the merchant device SP2 and the purchaser device SP0.

The merchant device SP2 may be configured through the application software (see SP2.1 of FIG. 1) inside SP2 to notify the device SP1 through the Custom Made Device SP1, instead of or in addition to the notification by the server 200 to device SP0.

Devices SP0 and SP2 can be a smartphone or any such other internet enabled device capable of interacting through the internet with server 200 and each SP0 and SP1 enabled to interact with each other through the Custom Made Device SP1. The device SP1 is a passive repeater inside a custom made mechanical structure SP1 made of a solid material with inside a bidirectional passive repeater, being such passive repeater two antennas connected electrically by an electric conductor such as but not limited by cables, or separate mechanical tunnels insulated between them as to not leak any light or at least attenuate sufficiently the light or sound between the two tunnels as to allow two separate unidirectional mechanical tunnels inside SP2 to function in one direction from device SP0 to SP2 and the other in one direction from device SP2 to SP0 through SP1.

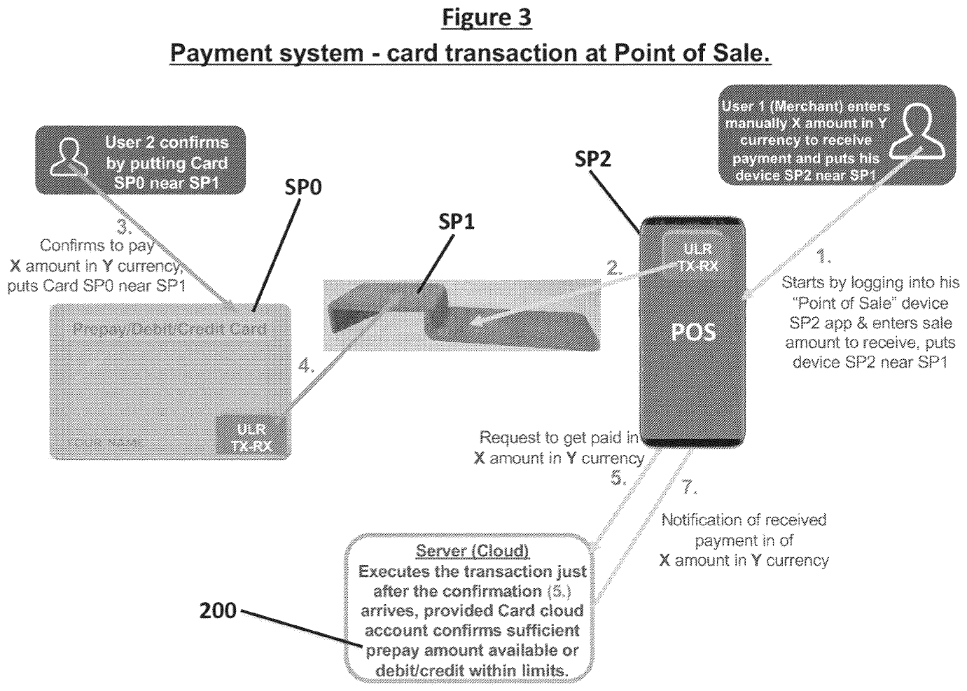

FIG. 3 represents another embodiment of the present invention, of a payment transaction at a point of sale, whereby the user of SP2 is a merchant whereby downloading an application software (SP2.1 of FIG. 1) configures the device SP2 into a point of sale (POS) device SP1. The merchant (user of SP2) enters the amount that the buyer (user of SP0 wherein SP0 is a prepaid-, debit-, credit-, or custom made Card) needs to pay for the merchandise or services rendered by the merchant. The merchant then puts his POS device SP2 on the Custom Made Device (SP1) lower longer end flat side of device SP1 which acts as a passive repeater between the merchant device and the purchaser device on the opposite side of SP1. The user who makes the purchase confirms the purchase by approaching his device SP0 near the Custom Device SP1, on the higher area flat side, which functions as a passive repeater between device SP0 and device SP1.

In this case one of the two devices, SP0 has no internet connection and in which case the merchant device SP2 is configured to require only SP2 to send a transaction confirmation to the server 200. The server 200 may be optionally configured to send a confirmation notification only to the merchant device or to the merchant device SP2 and the smartphone associated to the Card SP0. Device SP2 can be a smartphone or any such other internet enabled device capable of interacting through the internet with server 200 and each SP0 and SP1 enabled to interact with each other through the Custom Made Device SP1. The device SP1 is a passive repeater inside a custom made mechanical structure SP1 made of a solid material with inside a bidirectional passive repeater, being such passive repeater two antennas connected electrically by an electric conductor such as but not limited by cables, or separate mechanical tunnels insulated between them as to not leak any light or at least attenuate sufficiently the light or sound between the two tunnels as to allow two separate unidirectional mechanical tunnels inside SP2 to function in one direction from device SP0 to SP2 and the other in one direction from device SP2 to SP0 through SP1.

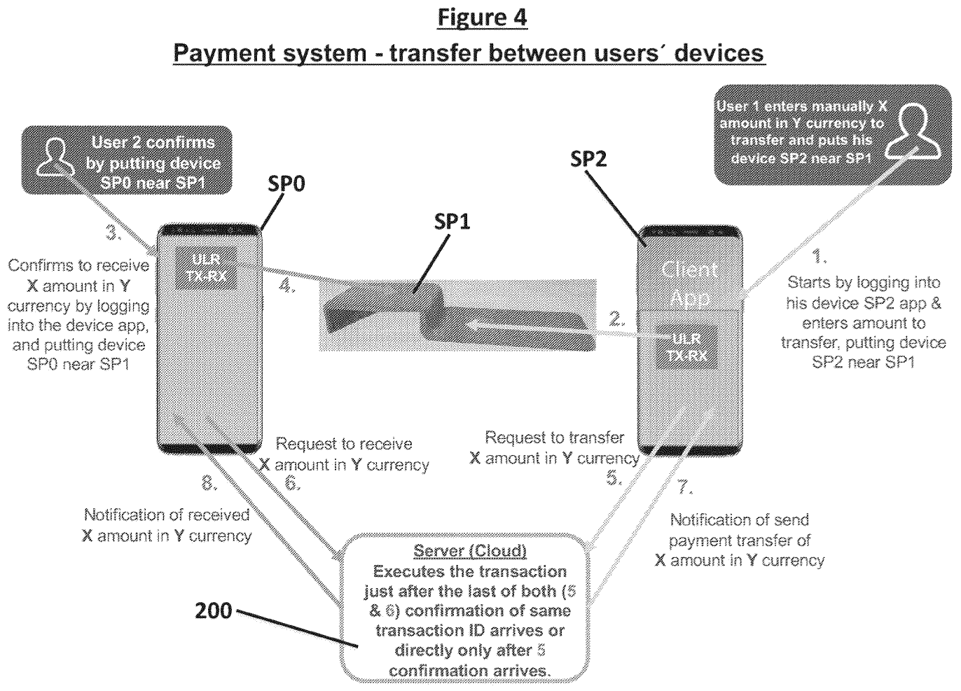

FIG. 4 represents a digital asset transfer embodiment of the present invention, wherein FIG. 1 merchant device SP2 is replaced by another non-merchant user device SP2. Wherein both SP0 and SP2 are configured to send and receive digital assets between them or through the Custom Made Device SP1 and the server 200. The digital asset can be any digitally stored value, in example money in any currency (example EURO, $US, GBP, etc.) or any token or crypto (BTC, ETH, USDT, USDC, etc.) or any such other digitised value assets.

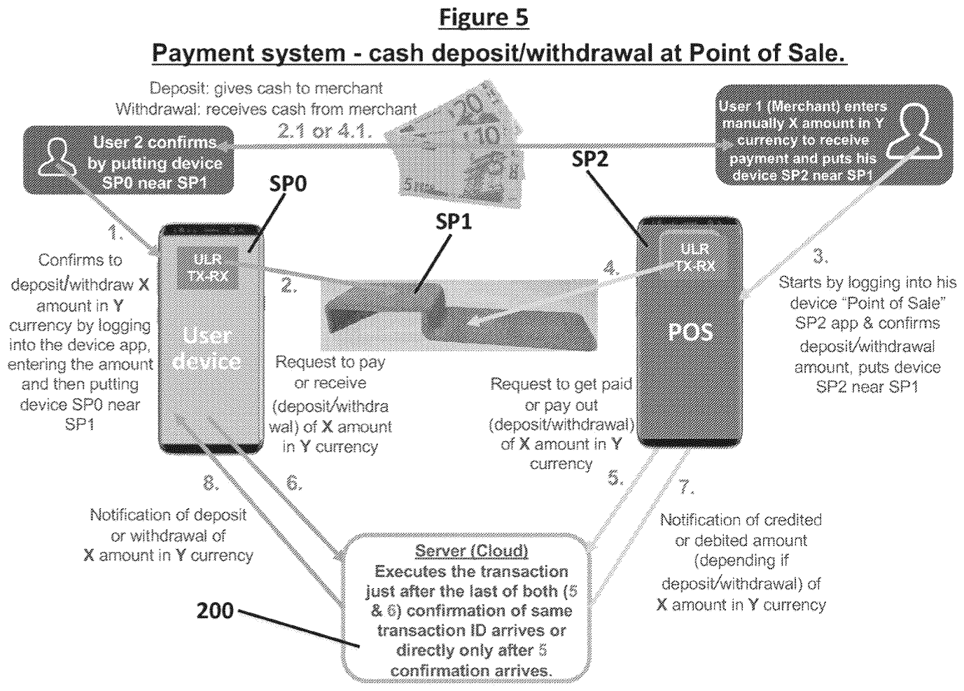

FIG. 5 represents a cash deposit/withdrawal embodiment of the present invention, wherein merchant device SP2 is configured by the software application SP2.1 of FIG. 1 to act as a virtual ATM (automated teller machine) or also known more commonly as a cash machine. Wherein both SP0 and SP2 are configured to send and receive cash in the form of digital assets between them or through the Custom Made Device SP1 and the server 200. The cash in digital asset form, can be any digitally stored value, in example government issued money converted into any digital currency (example EURO, $US, GBP, etc.) or converted into any token or crypto, including any such so called stable coins (BTC, ETH, USDT, USDC, etc.) or any such other digitised value assets.

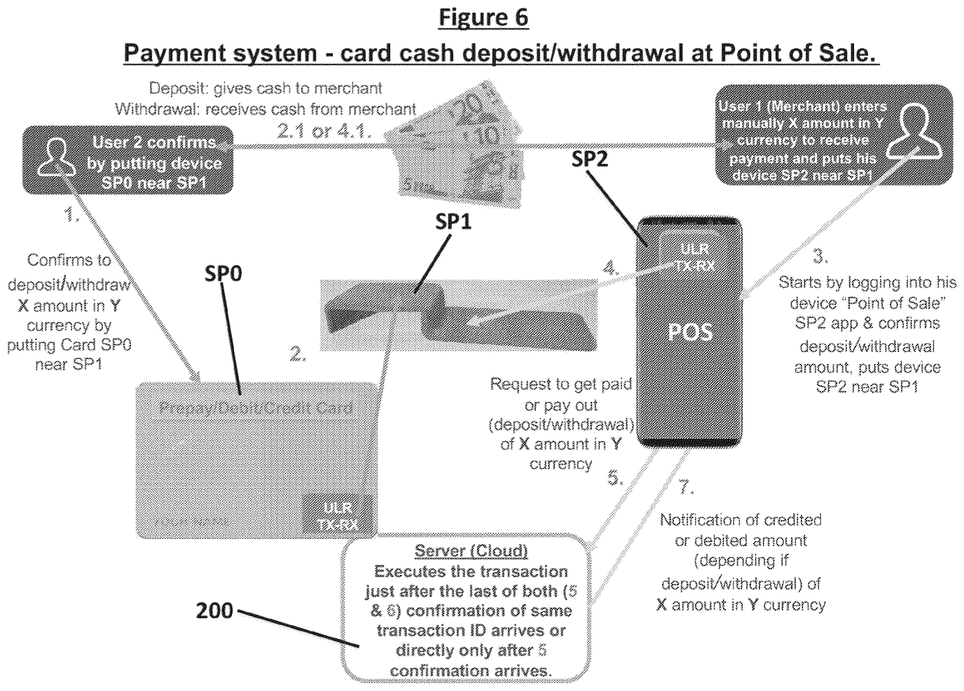

FIG. 6 represents a cash deposit/withdrawal embodiment of the present invention, wherein merchant device SP2 is configured by the software application SP2.1 of FIG. 1 to act as a virtual ATM (automated teller machine) or also known more commonly as a cash machine. Wherein SP0 is configured to make payments or send money or digital assets by payment transfer and SP2 is configured to send and receive cash or known as government issued money in the form of digital assets between them or through the Custom Made Device SP1 and server 200. The ULR TX/RX (ultra-low-range transceiver) can be NFC- or BLE-transceiver, or audio- or light-separate emitter & receiver (audio or light transceiver).

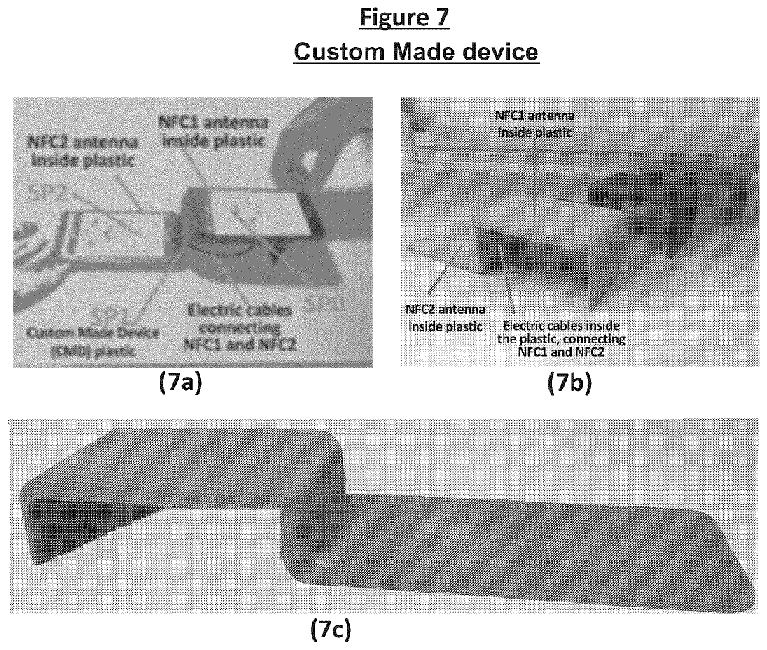

FIG. 7 represents the Custom Made Device SP1 in different embodiments of the present invention. 7a shows an actual prototype of SP1 made of plastic made with a 3D printer with two slots to slide in an NFC antenna: one inserted inside the higher part with the two cables of the NFC antennas to the outside of the plastic and one inserted inside the lower part with the two cables of that NFC antennas to the outside of the plastic. The cables of one NFC antenna are interconnected with the cables of the other NFC antenna, thus forming a passive transceiver. The 7b shows a more advanced prototype built after 7a with the cables connected for both antennas inside the plastic of the Custom Made Device. Also, 7b shows different sizes of the Custom Made Device (CMD) accommodating for different sizes of the SP2 device, in example but not limited to for different widths and lengths of smartphones that are intended to be put on top of the flat plastic part that is on the lower side of the CMD. On the other hand 7c was built as a final version embodiment of the Custom Made Device designed with a CAD system and built with a steel injection mould as two plastic parts and putting inside one of the different types of transceivers described herein this invention, for example mechanical guides to pass light or low frequencies (audible or non-audible frequency spectrum band) from one side of the CMD (SP1) to the other side or in other words from the side of SP0 to the side of SP2 and vice versa.

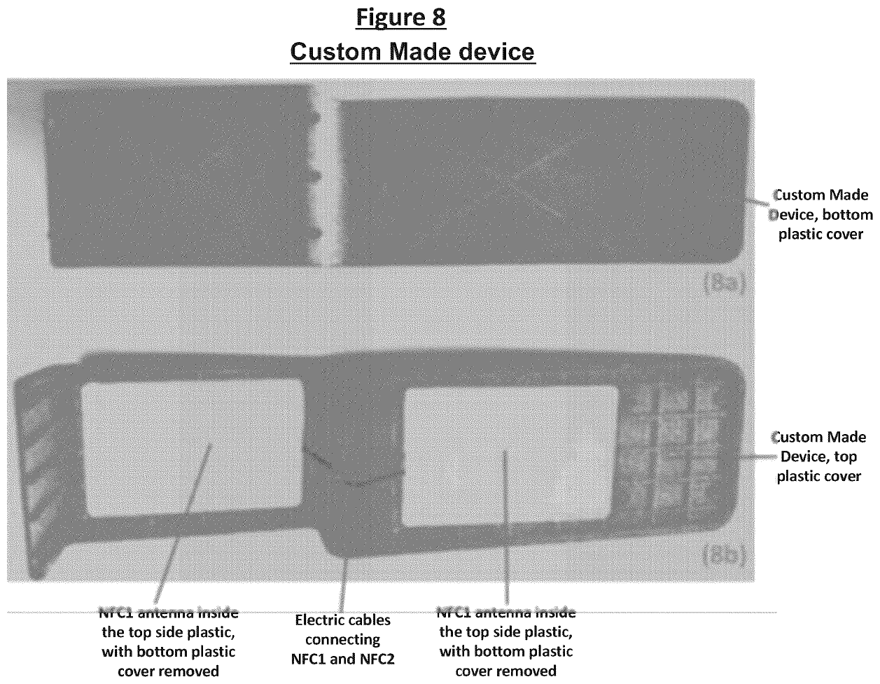

FIG. 8 represents the Custom Made Device of 7c showing all the parts of one embodiment of the present invention, in example in the event the transceiver is made of 2 NFC or BLE antennas interconnected electrically with each other passively without any active components and no power supply. One device (example SP2) transmits through the antenna inside on one side of the CMD (SP1) to other same antenna on the other side of the CMD to another device (example SP0). In this embodiment the different parts are a bottom part custom made plastic cover, a top part custom made plastic cover, two antennas inserted in the space provided in the top plastic cover, two cables interconnecting the 2 antennas through the space provided in the top plastic cover, and finally the two plastic parts fit such that the bottom cover fits and clicks into the top cover closing up the CMD as finished goods CMD unit that looks like FIG. 7a. In one embodiment the NFC or BLE antenna are a similar size as an existing standard plastic credit/debit card.

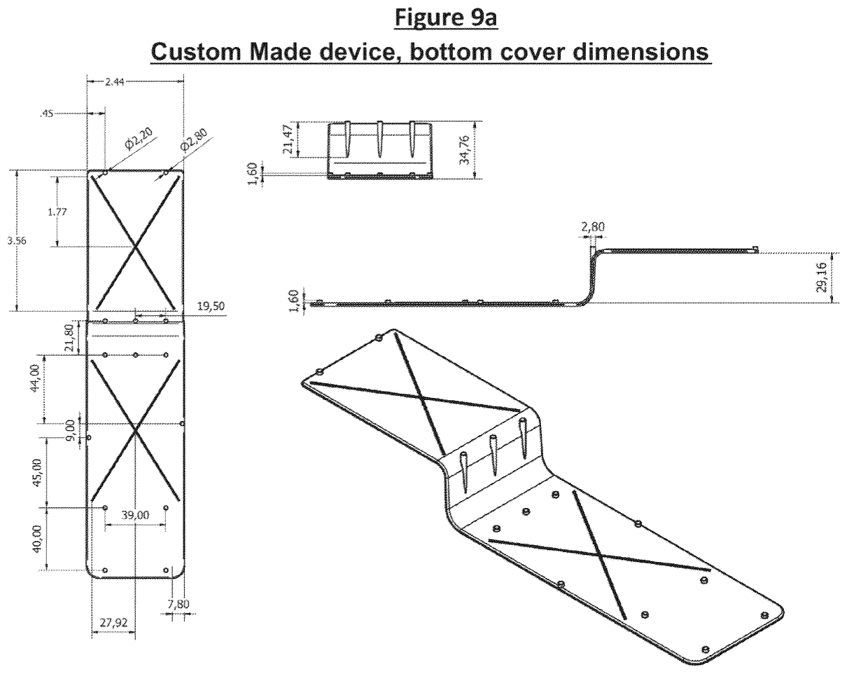

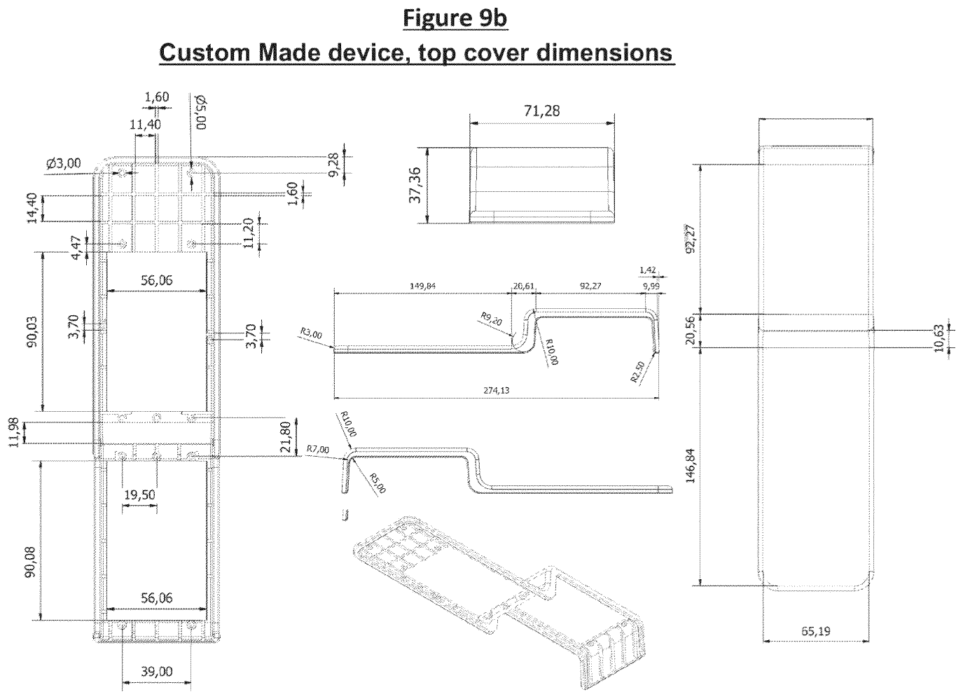

FIGS. 9a and 9b represent the Custom Made Device (7c of FIG. 7) showing all the different dimensions in millimetres, wherein R stands for radius of the curve, of the mechanical parts of FIG. 8 shown from the 3D design tool as another specific different embodiment of the present invention. FIG. 9a is the bottom plastic custom part and FIG. 9b is the top plastic part of the Custom Device, wherein the top part of FIG. 9b is the part where on the inside the mechanical repeater guide tunnels are built into the plastic to guide the light or audible or non-audible sound from one side of the Custom Made Device to the other side of the Custom Made Device, or where the space is left to insert two antennas, one of each side of the Custom Made Device, interconnected electrically to form a radio-repeater for wireless transceivers of wireless devices such as smartphones. The bottom cover clicks mechanically into the clips foreseen to function as a cover to close the Custom Made Device to protect the internal repeater parts.

As for FIGS. 1 to 6. A user of devices SP0, SP2 to SPn account are typically user of smartphones—or payment Cards—or any such other Custom Made Devices—who have created a user account on the system server 200 having passed KYC (know your customer). Typically, KYC means users uploading a proof of identity document and in some cases a proof of address document and in some other cases a selfie or a selfie holding the identity document. The prior art has cloud based systems that verify the likelihood of a selfie matching the identity document but stops short of considering changes in the users' change of looks or are not reliable when users wear glasses or have a beard or other changes over time and uses the ID document as the principal source of information to decide if a user will be accepted to create a new account user. In an embodiment of this invention the selfie of the user is the principal information to decide if a new user account is allowed to be created or not, based on criteria such as that same selfie matches an already existing account and thus is denied to create for example more than x accounts or that same selfie matches above a certain percentage likelihood an already other past user flagged as potential risk or fraud and is denied to create any account.

In another embodiment of the present invention the system server (200) and the Software Applications (SP0.1, SP2.1 to SPn.1) are configured to improve on the prior art as to be more compliant with AML/ATF (anti-money laundering/anti-terrorist financing) by detecting identity theft or users creating multiple accounts with same or different emails or different identity documents AND by detecting a user that was flagged in past as fraudulent or potentially in breach of the law to identify any additional accounts created or new accounts being created by the following method: if a user attempts to create more than one account with the same email or telephone number or same device (in example, same smartphone) as an existing account then the selfie of that user is flagged as potential breach regardless if the new account creation was blocked from happening in the first place, OR

if a user attempts to create more than one account with the same name and birth date as an existing account then the selfie of that user is flagged as potential breach regardless if the new account creation was blocked from happening in the first place, OR

if a user attempts to create more than one account with the same identity document photo match or identity document number then the selfie of that user is flagged as potential breach regardless if the new account creation was blocked from happening in the first place, OR

if a user attempts to create more than one account with sufficient pre-defined percentage match of the selfie as any existing account then the selfie of that user is flagged as potential breach regardless if the new account creation was blocked from happening in the first place, OR

if a user attempts to create a new account or more than one account with sufficient pre-defined percentage match of his selfie comparing it to a selfie of any other existing account or of a selfie of any account from a third party database authorised to share it legally where such selfie was flagged as a risk or potential fraud or non-compliant user then the selfie of that user is flagged as potential breach and all the accounts where the selfie matches are blocked as potential fraud or non-compliant.

In a different embodiment of the present invention of FIGS. 1 to 6 the server 200 and Software applications SP0.1, SP2.1 to SPn.1 upon prior express permission granted by user of device SP1, or SP2 to SPn the corresponding software application will take a picture with the display side camera at each login attempt be it successful or not and regardless of the login selected method. For example a login may be done by entering a username and password, which if successful will then be complemented by requiring to enter a two factor verification security code which could be emailed only to account verified email if the username & password match the login credentials, or could be sent by SMS (short message service)/by notification only to account verified mobile number/verified notification device if the username & password match the login credentials, OR a login may be done by fingerprint recognition/face identification recognition/voice recognition with or without requiring a two factor security code.

In all the previous mentioned and any other possible login scenarios at the moment the user opens the Software app to the foreground and at the moment the user enters a first character in any of the login fields, then;
(i) a photo is taken with the camera at the display side and sent to the server 200 which will verify if there is a match with the selfie of that account holder which is a verified selfie at account creation, if the match is high then no action is taken but if the match is low then the account is blocked and the account holder is notified by all means available to contact the user in an automated manner informing him of a potential hack or fraud on his account and to change his login credentials, and
(ii) a photo is taken with the other camera at the back side or battery side and sent to the server 200 which will use it only in the event of potential fraud or hack detected in previous point (i) to provide additional information of the surroundings with a potential visual of the location where the potential fraud or hack was committed from for the legal authorities to deal with to increase the chance of a potential successful prosecution.

An account blocked for fraud by the server 200 extends to any other account in the server 200, having an equal or above the set percent match of the selfie of the photo taken when the potential fraud or hack was detected during login or app opening to foreground.

The prior art makes use of the user's mobile phone as one of the alternatives to authenticate a user and as a means of a secondary channel to send an SMS (short message service) to the user with a two-factor authentication code. This means that the payment system would have the high cost of SMS volumes being sent by their system servers when large amount of users' requiring just to authenticate or verify their mobile phone numbers by the system. In a different embodiment of the present invention, this shortcoming is solved by offloading the system server 200 of this invention not requiring to send any SMS through any paying third party but instead using a method in the devices software applications SP0.1, SP2.1 to SPn,1 wherein the software application of each device, that is detected of having an active SIM, to generate a random two factor authentication code, and with the explicit permission of the device user an SMS with that code is sent to the mobile phone number the user entered to verify his phone number. The method will monitor incoming SMS and extract the content only from the sender having the same mobile phone number as the one entered by the user and if the authentication code matches the random generated code that was sent out then that mobile number is reported by the corresponding software module to the system server 200 confirming that mobile number of that user account has been authenticated. In effect this is a method to send an automated predefined SMS to the same device BUT if the device that the user is using is not the same one as that of the device with the mobile number he entered, then the user will be prompted to enter the authentication code by hand to complete the mobile number authentication process.

As a data protection method in this embodiment of the payment system, the use of a unique transaction code is limited to a maximum pre-set amount of days (for example 3 days) and if not executed then the transaction will be cancelled and funds returned to the paying party AND a same user account is not allowed to create multiple consecutive different unique codes, meaning not allowed to create multiple consecutive transactions unless the different transaction codes are generated at least separated by a pre-set minimum time (for example 500 milli seconds) between them to avoid repeating same transaction being executed by user mistake or by multiple consecutive key clicks.

There is disclosed a system and method of operating a payments system using a Custom Made Device (CMD) not requiring any power supply, or such CMD in combination with an adapted smartphone (AS) jointly, can form a novel point of sale (POS). This invention improves on the prior art shortcomings allowing merchants and users alike more choice of using this invention for different payment systems that makes use of a novel Custom Made Device (CMD) or a novel Point Of Sale (as a combination of using a CMD and an adapted smartphone) increasing competition in the marketplace in a more reliable way than without using the CMD. Additionally the invention increases the reliability of users transacting directly between them through their smartphones or such other devices by instead of interacting directly between the user device to interact through the Custom Made Device of this invention acting as a passive repeater between both devices. Many modifications and variations or different embodiments of this present invention are possible in view of the disclosures herein of this invention text, figures, drawings and explanations. It is to be understood that, within the scope of the appended claims, the invention can be practiced other than as specifically described in the claims or text of this invention. The invention which is intended to be protected should not, however, be construed as limited to the particular forms disclosed, or implementation examples outlined, as these are to be regarded as illustrative rather than restrictive. Variations and changes could be made by those skilled in the art without deviating from the novelty of the invention. Accordingly, the detailed descriptions and figures of this invention should be considered exemplary in nature and not limited to the novelties of the invention as set forth in the claims.

### Concepts

1. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple Custom Made Device (SP1), each custom made device including a passive repeater, one or multiple system server (200), each system server including a custom software module (200.1) and wherein;
   a) the wireless devices (SP0, SP2, SP3, SP4, . . . SPn) are Internet enabled wireless devices, smartphones or tablets, each wireless device (SP0, SP2, SP3, SP4, . . . SPn) also including at least one or more different built-in ultra-low range transceiver, NFC or BLE or audible or non-audible frequency spectrum transceiver or light transceiver, wherein each wireless device upon downloading the custom software application is operable as a paying device or as a payment receiving device and operable to communicate with the system server and the server custom software,
   b) the Custom Made Device(s) (SP1) are a custom made device enabled as a repeater of the wireless devices communications, from and to smartphones or tablets, each Custom Made Device also including at least one or more different built-in ultra-low range transceiver, NFC or BLE or audible or non-audible frequency spectrum transceiver or light transceiver, wherein each wireless device (SP0) upon being near to the Custom Made Device is operable to communicate with another different wireless device (SP2) when SP2 is near to the Custom Made Device,
   c) wherein each respective custom software application (appl) (SP0.1, SP2.1, SP3.1, SP4.1, . . . SPn.1) is operable when downloaded into the respective wireless device (SP0, SP2, SP3, SP4, . . . SPn), such wireless device when in proximity of the Custom Made Device communicates with another software application of another wireless device, wherein a payment transaction can be initiated by the wireless device of the receiving party in the event of a merchant and executed when the paying user device is in proximity of the Custom Made Device configured as a repeater, or initiated by the user in the event of an outgoing payment transfer to another user executed when both users wireless devices are in near proximity of the Custom Made Device (repeater),
   d) wherein the execution of the transaction requires the paying and the receiving party to be in near proximity of the Custom Made Device (repeater) and wherein both devices send the payment send request and payment receive request respectively to the system server custom software application for consolidation of the actual transaction and account updating of both wireless devices user's accounts and notifying the wireless devices with a confirmation of executed payment transaction.
2. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple system server (200), each system server including a custom software module (200.1) and wherein;
   a) the system server 200 is not configured to send any mobile SMS (short message service) to any wireless devices,
   b) the custom software application (SP0.1, SP2.1 to SPn, 1) is downloaded into a wireless device (SP0, SP2, SP3, SP4, . . . SPn), the wireless device is operable to detect if that wireless device has an active SIM (subscriber identity module), and with the explicit permission of the wireless device user an SMS is sent by the custom software application with payload of a random generated authentication code (RGAC1) to the mobile phone number of the wireless device and wherein, the custom software application extracts the content from incoming SMS originated from or with caller ID which has the same phone number as the wireless device and confirms the phone number to be authenticated only if an incoming SMS is received with the same previous mentioned random code (RGAC1),
   c) if no match is received of that RGAC1 within a fixed set time (Ti) then the custom application software prompt the user through the wireless device display that the mobile phone number cannot be authenticated as it is different than the SIM phone number of the present wireless device,
   d) if the custom software application confirms the received RGAC1 to be the same as the one generated before and sent by SMS by the custom software application, then the custom software application will inform the system server 200 confirming that the mobile number of that user account has been authenticated.
3. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple system server (200), each system server including a custom software module (200.1) and wherein;
   a) the custom software application when downloaded into the wireless device auto configures a wireless device as a virtual ATM allowing cash deposits between two different wireless device users wherein one is configured as a merchant/virtual ATM to receive cash and the other is configured to receive electronic payment from the wireless device of the merchant/virtual ATM wireless device in the same amount as the cash handed over to the merchant/virtual ATM wireless device user, with the transaction executed through the custom software module of the system server, or
   b) the custom software application system when downloaded into the wireless device auto configures a wireless device as a virtual ATM allowing cash deposits between two different wireless device users wherein one is configured as a merchant/virtual ATM to hand over cash and the other is configured to send electronic payment from the wireless device of the merchant/virtual ATM wireless device in the same amount as the cash received from the merchant/virtual ATM wireless device user, with the transaction executed through the custom software module of the system server.
4. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple Custom Made Device (SP1), each custom made device including a passive repeater, one or multiple system server (200), each system server including a custom software module (200.1) and wherein;
   a) One or both of the wireless devices has a protective cover that prohibits the wireless devices to communicate directly between them, and wherein
   b) the custom software application system when downloaded into the wireless device auto configures a wireless device as a paying wireless device or as a payment receiving wireless device wherein one wireless device is configured to receive payments and another wireless device is configured to make payments, wherein the sending and receiving transaction is executed through the custom software module of the system server when both wireless devices are put in proximity of the passive repeater on each side of the Custom Made Device.
5. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple Custom Made Device (SP1), each custom made device including a passive repeater, one or multiple system server (200), each system server including a custom software module (200.1) and wherein;
   a) One of the wireless devices has a protective cover that prohibits the wireless devices to communicate directly between them, and wherein
   b) the custom software application when downloaded into the wireless device auto configures one wireless device 1 as a paying wireless device 1 and the other wireless device 2 as a payment receiving wireless device 2 wherein one wireless device 2 user upon first account opening hands over the amount of cash 1 to the other wireless device 1 user and wherein the custom software application of wireless device 1 makes payment in the amount of cash 1, wherein
   c) the transaction is started at when wireless device 1 and wireless device 2 are put in near proximity of the repeater on each side of the Custom Made Device where through wireless device 1 and wireless device 2 communicate with each other, and is then executed through the server custom application software sending the amount of cash 1 in electronic form from the account of wireless device 1 to the account of wireless device 2.
6. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple Custom Made Device (SP1), each custom made device including a passive repeater, one or multiple system server (200), each system server including a custom software module (200.1) and wherein;
   a) one of the wireless devices (SP0) has no internet connection that prohibits the wireless devices to communicate directly with the system server (200), and wherein
   b) the custom software application when downloaded into the wireless device auto configures one wireless device (SP0) as a paying wireless device and the other wireless device (SP2) as a payment receiving wireless device wherein wireless device SP0 when making payment directly contactlessly to wireless device SP2, wireless device SP2 automatically shares the credentials of the internet sharing medium from wireless device SP2 and wherein the custom software application of wireless device SP0 uses the received credentials to connect to the internet sharing medium of wireless device 2 and makes payment, wherein
   c) the transaction is started when wireless device 1 and wireless device 2 are put in near proximity of the repeater on each side of the Custom Made Device where through wireless device 1 and wireless device 2 communicate with each other, and is then executed through the server custom application software sending the amount of cash 1 in electronic form from the account of wireless device 1 to the account of wireless device 2.
7. A payments system, comprising of wireless devices (SP0, SP2, SP3, SP4, . . . SPn), each wireless device including a respective downloaded custom software application (SP0.1, SP2.1, SP3.1, SP4.1, . . . SPn.1), one or multiple Custom Made Device (SP1), each custom made device including a passive repeater, one or multiple system server (200), each system server including a custom software module (200.1) and wherein;
   a) the custom software application when downloaded into the wireless device auto configures one wireless device (SP0) as a paying wireless device and the other wireless device (SP2) as a payment receiving wireless device wherein wireless device SP0 when making payment directly contactlessly to wireless device SP2, wireless device SP2 automatically shares the credentials of the internet sharing medium from wireless device SP2 and wherein the custom software application of wireless device SP0 uses the received credentials to connect to the internet sharing medium of wireless device SP2 to communicate with the server 200 to make the payment, wherein
   b) the payment transaction is started at the time when wireless device SP0 and wireless device SP2 are put in near proximity of the repeater on each side of the Custom Made Device where through wireless device SP0 and wireless SP2 communicate with each other, and wherein
   c) both wireless device SP0 and wireless device SP2 send a transaction request to the system server 200, one to send and the other to receive the same amount with a same transaction code that expires in a present timeframe, and wherein
   d) the server custom application software 200.1 ignores any transaction requests with the same transaction ID if the previous transaction was within a preset timeframe (example 400 milliseconds), and wherein
   e) the server custom application software 200.1 only executes the transaction of sending the payment amount from the account of wireless device SP0 to the account of wireless device SP2, if a transaction request is received from both custom application software SP0.1 of wireless device SP0 and from custom application software SP2.1 of wireless device SP2 with the same transaction ID and the same absolute amount from both.
8. A payments system of any of the preceding concepts, wherein the wireless devices (SP0, SP2, SP3, SP4, . . . SPn), and the multiple Custom Made Device (SP1), are configured to communicate with each other directly, wherein the communications method between the wireless devices directly are through one of the following ultra-low range transceivers;
   a) NFC (near field communications), or
   b) audio in the inaudible frequency range for humans, or
   c) or light in the non-visible range for humans.
9. A payments system of any of the preceding concepts, wherein the wireless devices (SP0, SP2, SP3, SP4, . . . SPn), and the multiple Custom Made Device (SP1), are configured to communicate with each other indirectly through the Custom Made Device and wherein the communications method between the wireless devices through the Custom Made Device repeater are through one of the following ultra-low range transceivers;
   d) NFC (near field communications), or
   e) audio in the inaudible frequency range for humans, wherein the Custom Made Device is configured with 2 independent and sound insulated audio guides to transport the sound emitted by wireless device SP0 through a dedicated mechanical audio guide tunnel X inside the Custom Made Device SP1 to wireless device SP2 and a separate audio tunnel Y with sufficient mechanical attenuation from the audio through tunnel X, wherein tunnel Y transport the sound emitted by wireless device SP2 through a dedicated mechanical audio guide tunnel Y inside the Custom Made Device SP1 to wireless device SP0, or
   f) light in the non-visible range for humans, wherein the Custom Made Device is configured with 2 independent and light insulated light guides (in example fiber glass, translucent Plexiglas) to transport the light emitted by wireless device SP0 through a dedicated mechanical light conductor guide tunnel X inside the Custom Made Device SP1 to wireless device SP2 and a separate light conductor tunnel Y with sufficient mechanical light attenuation from the light through tunnel X, wherein tunnel Y transports the light emitted by wireless device SP2 through a dedicated mechanical light conductor guide tunnel Y inside the Custom Made Device SP1 to wireless device SP0.
10. A payments system of any of the preceding concepts, wherein the Custom Made Device acts as a repeater between the wireless devices, and wherein the Custom Made Device acts as a passive repeater, and wherein the Custom Made Device is configured to function without any power supply.

1. A payments system, comprising wireless devices, each wireless device including a respective downloaded custom software application, the payments system further comprising one or multiple Custom Made Devices, each custom made device including a passive repeater, the payments system further comprising one or multiple system servers, each system server including a custom software module, wherein:
a) the wireless devices are Internet enabled wireless devices, smartphones or tablets, each wireless device also including at least one built-in ultra-low range transceiver, which is a near-field communications (NFC) transceiver or a Bluetooth low energy (BLE) transceiver, or an audible or non-audible frequency spectrum transceiver or a light transceiver, wherein each wireless device upon downloading the custom software application is operable as a paying device or as a payment receiving device and is operable to communicate with the system server and the server custom software;
b) the one or more Custom Made Devices are each a custom made device enabled as a repeater of the wireless devices communications, from and to smartphones or tablets, each Custom Made Device also including at least one built-in ultra-low range transceiver, which is a near-field communications (NFC) transceiver or a Bluetooth low energy (BLE) transceiver, or an audible or non-audible frequency spectrum transceiver or a light transceiver, wherein
each wireless device is configured such that upon being near to the Custom Made Device, it is operable to communicate with another different wireless device when the other different wireless device is near to the Custom Made Device,
c) wherein each respective custom software application (appl) is operable when downloaded into the respective wireless device such that the respective wireless device when in proximity of the Custom Made Device communicates with another software application of another wireless device, wherein a payment transaction can be initiated by the wireless device of the receiving party which is a merchant and executed when the paying user device is in proximity of the Custom Made Device configured as a repeater, or initiated by the user in the event of an outgoing payment transfer to another user executed when both users wireless devices are in near proximity of the Custom Made Device (repeater),
d) wherein the execution of the transaction requires the paying and the receiving party to be in near proximity of the Custom Made Device (repeater) and wherein both devices respectively send the payment send request and the payment receive request to the system server custom software application for consolidation of the actual transaction and account updating of both wireless devices user's accounts and notifying the wireless devices with a confirmation of an executed payment transaction.

2-3. (canceled)

4. A payments system, comprising wireless devices, each wireless device including a respective downloaded custom software application, the payments system further comprising one or multiple Custom Made Devices, each custom made device including a passive repeater, the payments system further comprising one or multiple system servers, each system server including a custom software module, wherein:
a) One or both of a first wireless device and a second wireless device has a protective cover that prohibits the first wireless device and the second wireless device to communicate directly between them, and wherein
b) the custom software application when downloaded into a respective wireless device auto configures the respective wireless device as a paying wireless device or as a payment receiving wireless device, wherein the first wireless device is configured to receive payments and the second wireless device is configured to make payments, wherein the sending and receiving transaction is executed through the custom software module of the system server when both the first wireless device and the second wireless device are put in proximity of the passive repeater on each side of the Custom Made Device.

5. A payments system, comprising wireless devices, each wireless device including a respective downloaded custom software application, the payments system further comprising one or multiple Custom Made Devices, each custom made device including a passive repeater, the payments system further comprising one or multiple system servers, each system server including a custom software module, wherein:
a) a first wireless device or a second wireless device has a protective cover that prevents the other wireless devices to communicate directly with the wireless device with the protective cover, and wherein
b) the custom software application when downloaded into the first wireless device and into the second wireless device auto configures the first wireless device 1 as a paying wireless device 1 and the second wireless device 2 as a payment receiving wireless device 2, wherein the second wireless device 2 user upon first account opening hands over the amount of cash 1 to the first wireless device 1 user and wherein the custom software application of first wireless device 1 makes payment in the amount of cash 1, wherein
c) the transaction is started when first wireless device 1 and second wireless device 2 are put in near proximity of the repeater on each side of the Custom Made Device where first wireless device 1 and second wireless device 2 communicate with each other, and is then executed through the server custom application software sending the amount of cash 1 in electronic form from the account of first wireless device 1 to the account of second wireless device 2.

6. A payments system, comprising wireless devices, each wireless device including a respective downloaded custom software application, the payments system further comprising one or multiple Custom Made Devices, each custom made device including a passive repeater, the payments system further comprising one or multiple system servers, each system server including a custom software module, wherein:
a) a first wireless device has no internet connection, which prohibits the first wireless device to communicate directly with the system server, and wherein
b) the custom software application when downloaded into the first wireless device and into the second wireless device auto configures the first wireless device as a paying wireless device and the second wireless device as a payment receiving wireless device, wherein the first wireless device, is configured to make payment directly contactlessly to the second wireless device, the second wireless device is configured to automatically share the credentials of the internet sharing medium from the second wireless device and wherein the custom software application of the first wireless device uses the received credentials to connect to the internet sharing medium of the second wireless device 2 and makes payment, wherein
c) the transaction is started when the first wireless device 1 and the second wireless device 2 are put in near proximity of the repeater on each side of the Custom Made Device where the first wireless device 1 and the second wireless device 2 communicate with each other, and the transaction is then executed through the server custom application software sending the amount of cash 1 in electronic form from the account of the first wireless device 1 to the account of the second wireless device 2.

7. A payments system, comprising wireless devices, each wireless device including a respective downloaded custom software application, the payments system further comprising one or multiple Custom Made Devices each custom made device including a passive repeater, the payments system further comprising one or multiple system servers, each system server including a custom software module, wherein:
a) the custom software application when downloaded into a first wireless device and into a second wireless device, auto configures the first wireless device as a paying wireless device and the second wireless device as a payment receiving wireless device wherein the first wireless device is configured to make payment directly contactlessly to the second wireless device, wherein the second wireless device automatically shares the credentials of the internet sharing medium from the second wireless device and wherein the custom software application of the first wireless device uses the received credentials to connect to the internet sharing medium of the second wireless device to communicate with the server to make the payment, wherein
b) the payment transaction is started at the time when the first wireless device and the second wireless device are put in near proximity of the repeater on each side of the Custom Made Device where the first wireless device and the second wireless communicate with each other, and wherein
c) both the first wireless device and the second wireless device send a transaction request to the system server, respectively to send and to receive the same amount with a same transaction code that expires in a present timeframe, and wherein
d) the server custom application software ignores any transaction requests with the same transaction ID if the previous transaction was within a preset timeframe (example 400 milliseconds), and wherein
e) the server custom application software only executes the transaction of sending the payment amount from the account of the first wireless device to the account of the second wireless device, if a transaction request is received from both custom application software of the first wireless device and from custom application software of the second wireless device with the same transaction ID and the same absolute payment amount.

8. The payments system of any of claim 1, wherein the wireless devices, and the multiple Custom Made Devices, are configured to communicate with each other directly, wherein the communications between the wireless devices directly are through one of the following ultra-low range transceivers;
a) NFC (near field communications), or
b) audio in the inaudible frequency range for humans, or
c) light in the non-visible range for humans.

9. The payments system of claim 1, wherein the wireless devices, and the multiple Custom Made Devices, are configured to communicate with each other indirectly through the Custom Made Device and wherein the communications between the wireless devices through the Custom Made Device repeater are through one of the following ultra-low range transceivers;
d) NFC (near field communications), or
e) audio in the inaudible frequency range for humans, wherein the Custom Made Device is configured with two independent and sound insulated audio guides to transport the sound emitted by wireless device through a dedicated mechanical audio guide tunnel inside the Custom Made Device to wireless device and a separate audio tunnel with sufficient mechanical attenuation from the audio through tunnel, wherein tunnel transports the sound emitted by wireless device through a dedicated mechanical audio guide tunnel Y inside the Custom Made Device to wireless device, or
f) light in the non-visible range for humans, wherein the Custom Made Device is configured with two independent and light insulated light guides (in example fiber glass, translucent Plexiglas) to transport the light emitted by wireless device through a dedicated mechanical light conductor guide tunnel inside the Custom Made Device to wireless device and a separate light conductor tunnel with sufficient mechanical light attenuation from the light through tunnel, wherein tunnel transports the light emitted by wireless device through a dedicated mechanical light conductor guide tunnel inside the Custom Made Device to wireless device.

10. The payments system of claim 1, wherein the Custom Made Device acts as a repeater between the wireless devices, and wherein the Custom Made Device acts as a passive repeater, and wherein the Custom Made Device is configured to function without any power supply.

11-19. (canceled)
